(19) United States
(12) Patent Application Publication
(10) Pub. No.: US 2003/0129538 A1
(43) Pub. Date: Jul. 10, 2003

(54) Method for eliminating corner round profile of the RELACS process

(75) Inventors: Wei-Hwa Sheu, Taichung (TW); Shun-Li Lin, Hsin-Chu (TW)

Correspondence Address: LOWE HAUPTMAN GILMAN & BERNER, LLP, Suite 310, 1700 Diagonal Road, Alexandria, VA, 22314, US

(73) Assignee: Macronix International Co., Ltd.

(21) Appl. No.: 10/040,361

(22) Filed: Jan. 9, 2002

(51) Int. Cl. G03C 5/00

(52) U.S. Cl. 430/311; 430/313; 430/322

(57) ABSTRACT

Forming a patterned photoresist over the substrate, herein numerous ions are formed during the formation of the patterned photoresist. Treat the patterned photoresist to increase the ions density at the top of the patterned photoresist. Cover the patterned photoresist by a reactive layer, wherein the reaction between the reactive layer and the ions forms a crosslinked layer over the surface of the patterned photoresist. And remove non-crosslinked portions of the reactive layer. Moreover, the treatment of the patterned photoresist could be heat the pattered photoresist or illuminate the patterned photoresist. Besides, the treatment also could be performed after the reactive layer is covered.

### BACKGROUND OF THE INVENTION

1. Field of the Invention

The present invention relates to a method for eliminating corner round profile of the RELACS (resolution enhancement lithography assisted by chemical shrink) process. More particularly, this invnetion relates to a method for eliminating corner round profile of the RELACS process by re-distributing ions or by re-forming ions after patterned photoresist being formed, whereby ions are formed during formation of patterned process.

2. Description of the Prior Art

The resolution enhancement lithography assisted by chemical shrink (RELACS) method is a new technology for improving the efficiency of the conventional photolithography technique. The RELACS method uses the crosslinking relation between the materials coated on the patterned photoresist, and the ions existed at the surface of the patterned photoresist.

The essential steps of the conventional RELACS method are briefly introduced as follows. By referring to FIGS. 1A through 1D, form patterned photoresist 11 on substrate 10, form reactive layer 12 over both substrate 10 and photoresist 11, where the reaction between reactive layer 12 and the ions at the surface of patterned photoresist 11 forms crosslinked layer 13 at the surface of patterned photoresist 11, and remove non-crosslinked portions of reactive layer 12. Significantly, because gap 14 between neighboring patterned photoresist 11 is partially filled by crosslinked layer 13, the critical dimension of the combination of patterned photoresist 11 and crosslinked layer 13 is smaller than the critical dimension of patterned photoresist 11. Thus, because the pattern of the combination would be transferred into underlying substrate 10, a mask with wider critical dimension could be used to form a semiconductor structure with narrower critical dimension, thus, the limitation of the wavelength could be exceeded.

Nevertheless, the distribution of the ions usually is not uniform at the whole surface of patterned photoresist 11, especially while the ions are formed by the reaction between the material of patterned photoresist 11 and the light used to expose patterned photoresist 11. The ions usually are concentrated at the sidewall of patterned photoresist 11, which means the ions density is lower at the top of patterned photoresist 11. Thus, for the real condition, the thickness of crosslinked layer 13 usually is not the uniform case which FIG. 1C shows, but usually is the non-uniform case shown in FIG. 1E, which usually is called as the corner round profile.

Hence, owing to both patterned photoresist 11 and crosslinked layer 13 would be etched during the etching process which transfers the pattern of the combination of patterned photoresist 11 and crosslinked layer 13 into substrate 10, especially the etching rate of patterned photoresist 11 usually is different from the etching rate of crosslinked layer. Clearly, an unavoidable defects of FIG. 1E is that the pattern inside substrate 10 maybe is different to the pattern of the combination of both patterned photoresist 11 and crosslinked layer 13, especially while portion of the combination being exhausted during the etching process.

Accordingly, the non-uniform distribution of ions is an unsolved defect of conventional RELACS method, and it is desired to overcome the defect for broadly applying the RELACS method to further enhance the efficiency of the photolithography technique.

### SUMMARY OF THE INVENTION

One main object of the present invention is to eliminate the corner round profile of the conventional RELACS process.

Another main object of the present invention is to let the ions be uniformly distributed at the surface of patterned photoresist.

This invention presents a method for eliminating corner round profile of the RELACS. Herein, the method at least has following steps: Form a patterned photoresist on a substrate, where numerous are distributed on the surface of the patterned photoresist, more, ions density is higher on the top of the patterned photoresist but is lower on the sidewall of the patterned photoresist. Treat the patterned photoresist to let the ions density on the top is about equal to the ions density on the sidewall. Cover the patterned photoresist by a reactive layer, where the reaction between the reactive layer and the ions would form a crosslinked layer over the surface of the patterned photoresist. Finally, remove non-crosslinked portion of the reactive layer. Furthermore, by illuminating to form new ions or by thermal treating to redistribute existent ions, the distribution of ions could be uniformed.

Significantly, this invention treats the patterned photoresist before it is covered by the reactive layer to let the ions density on the top of the patterned photoresist is about equal to that on the sidewall of the patterned photoresist. Thus, owing the formation of the crosslinked dependent on the ions density, the thickness of the crosslinked layer could be uniform and the problem of the corner round profile could be effectively eliminated.

### BRIEF DESCRIPTION OF THE DRAWINGS

A more complete appreciation and many of the attendant advantages thereof will be readily obtained as the same becomes better understood by reference to the following detailed description when considered in connection with the accompanying drawings.

FIG. 1A through FIG. 1E shows some essential steps of the conventional RELACS method and the corner round profile defects;

FIG. 2A through FIG. 2G shows the cross-sectional illuminations of some essential steps of one preferred embodiment of this present invention;

FIG. 3 shows the essential flow chart of another preferred embodiment of this present invention; and

FIG. 4 shows the essential flow chart of the other preferred embodiment of this present invention.

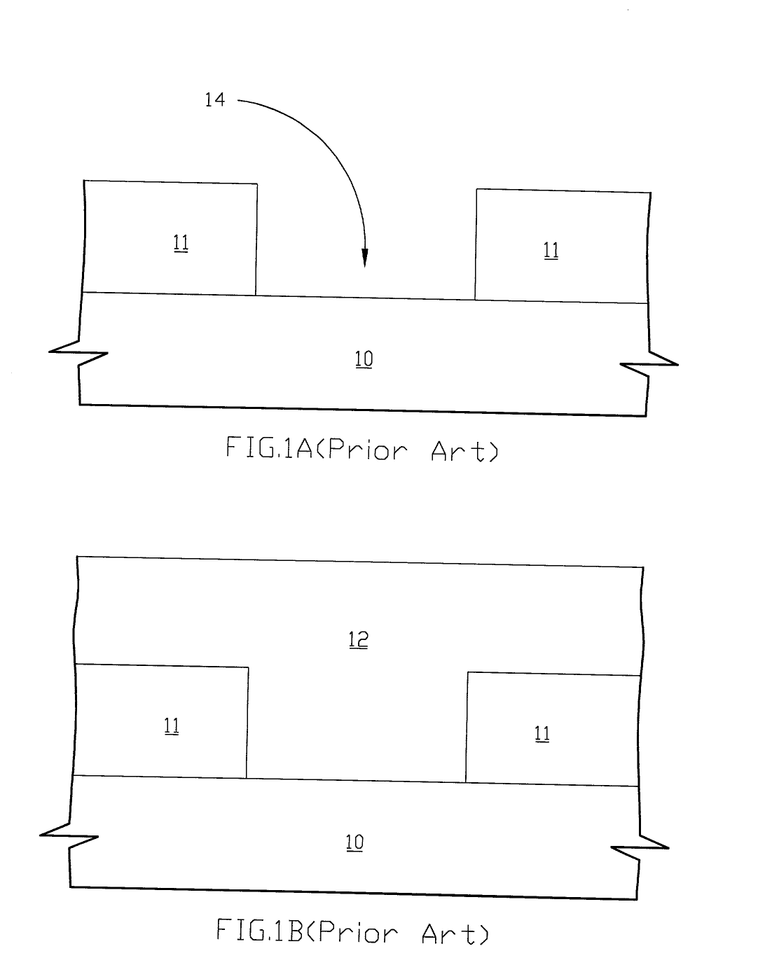

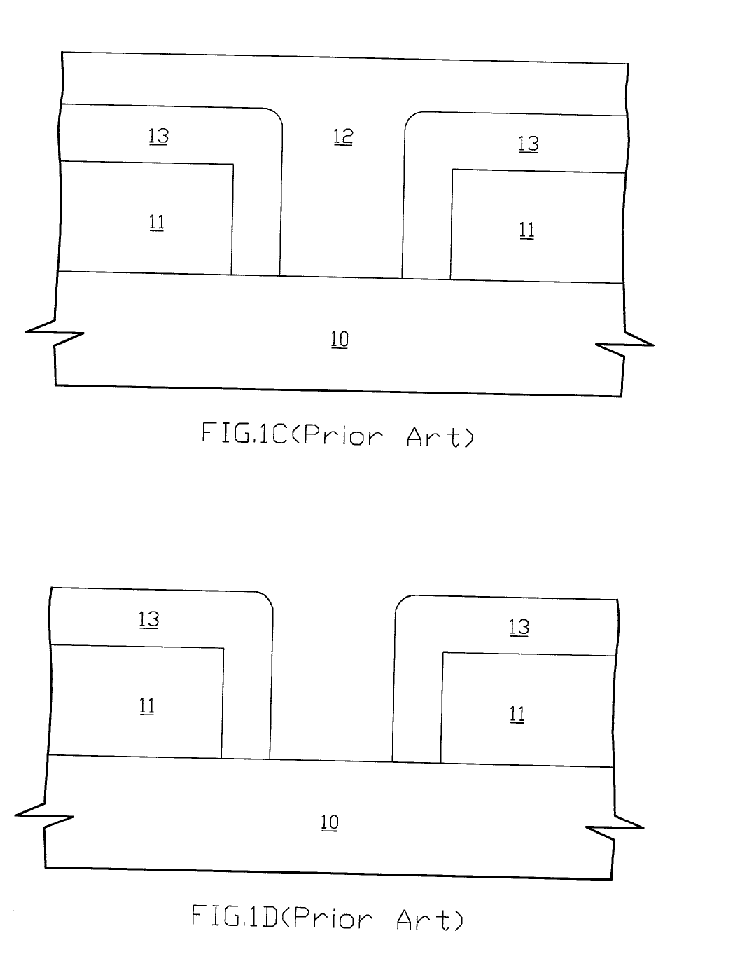

### DESCRIPTION OF THE PREFERRED EMBODIMENT

Some preferred embodiments are discussed in detail below, and are used to clearly explain this invention. However, it should be emphasized that this claimed invention could be applied to other applications and is not limited by these embodiments. Therefore, available scope of this invention is not limited by present embodiments but the claims.

One preferred embodiment of this present invention is a method for eliminating corner round profile of the RELACS process, the embodiment at least has following essential steps:

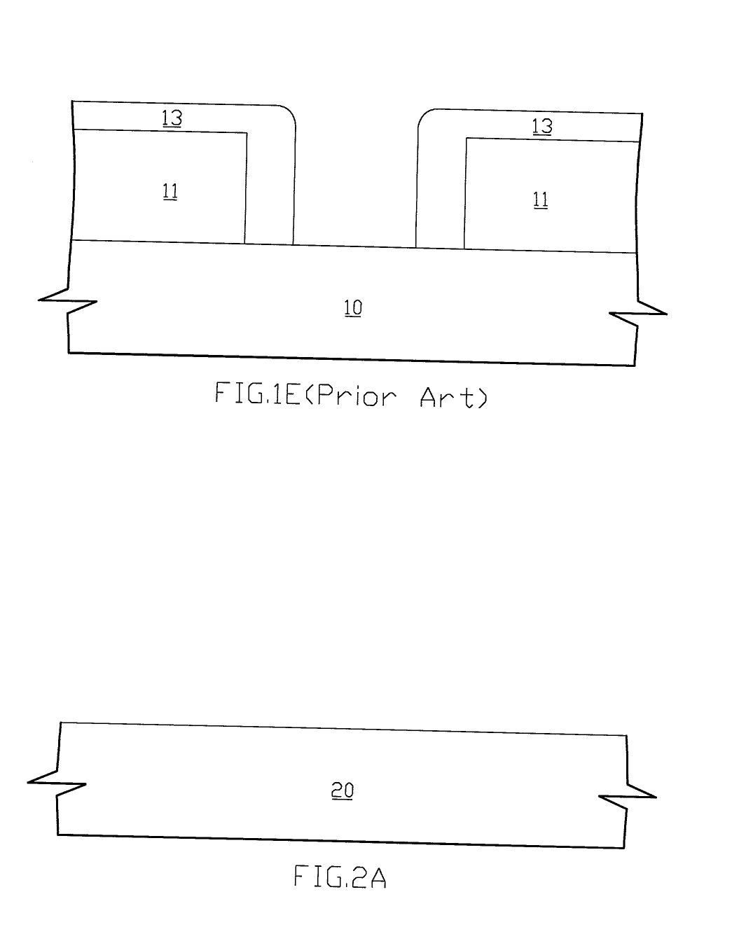

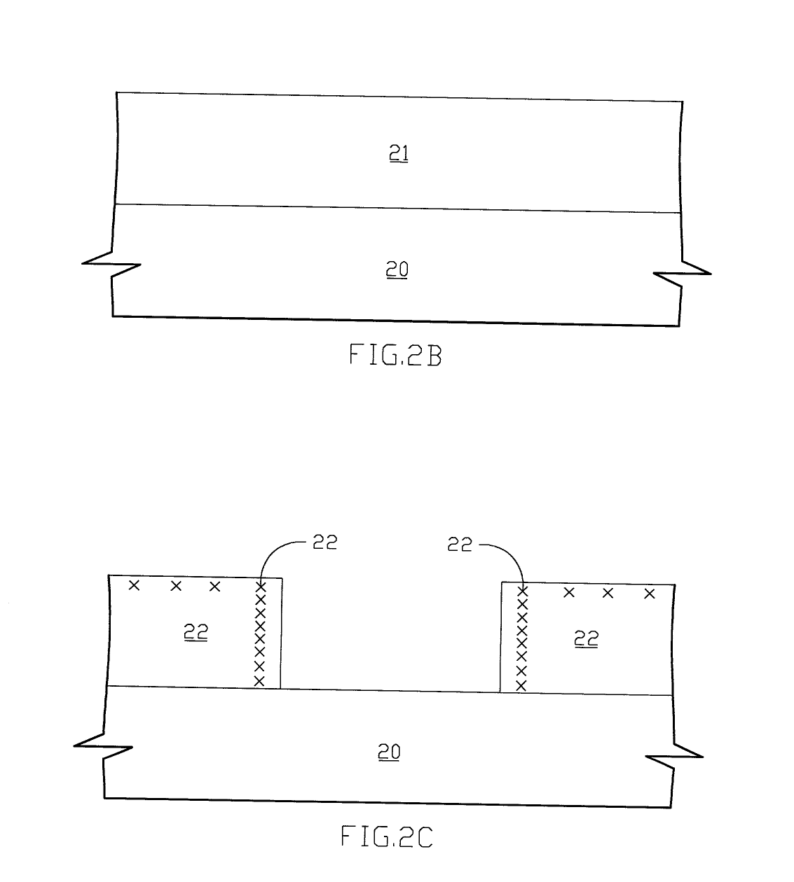

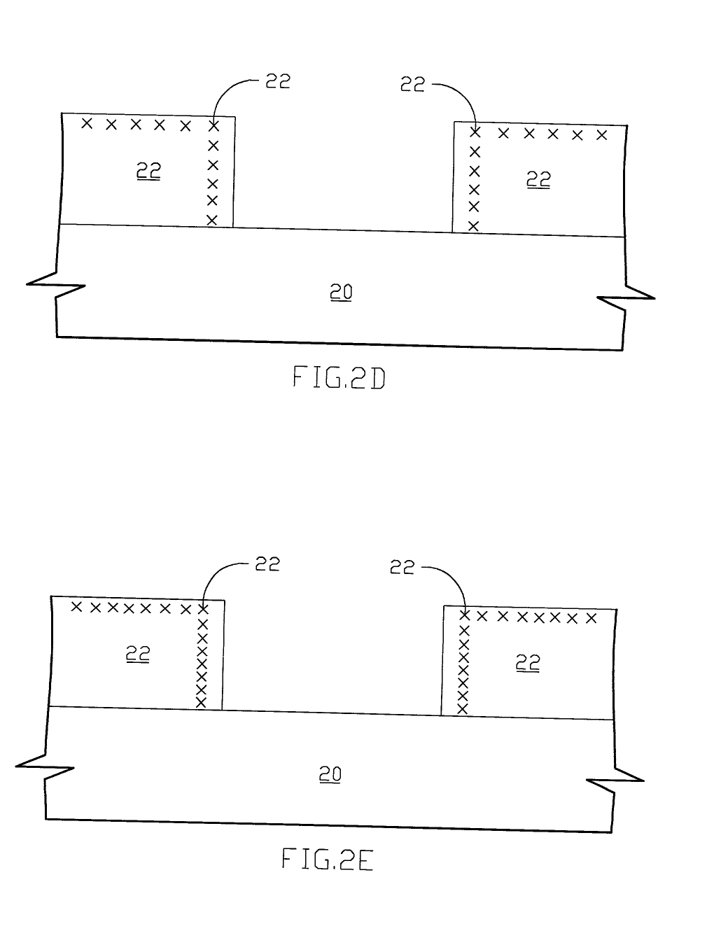

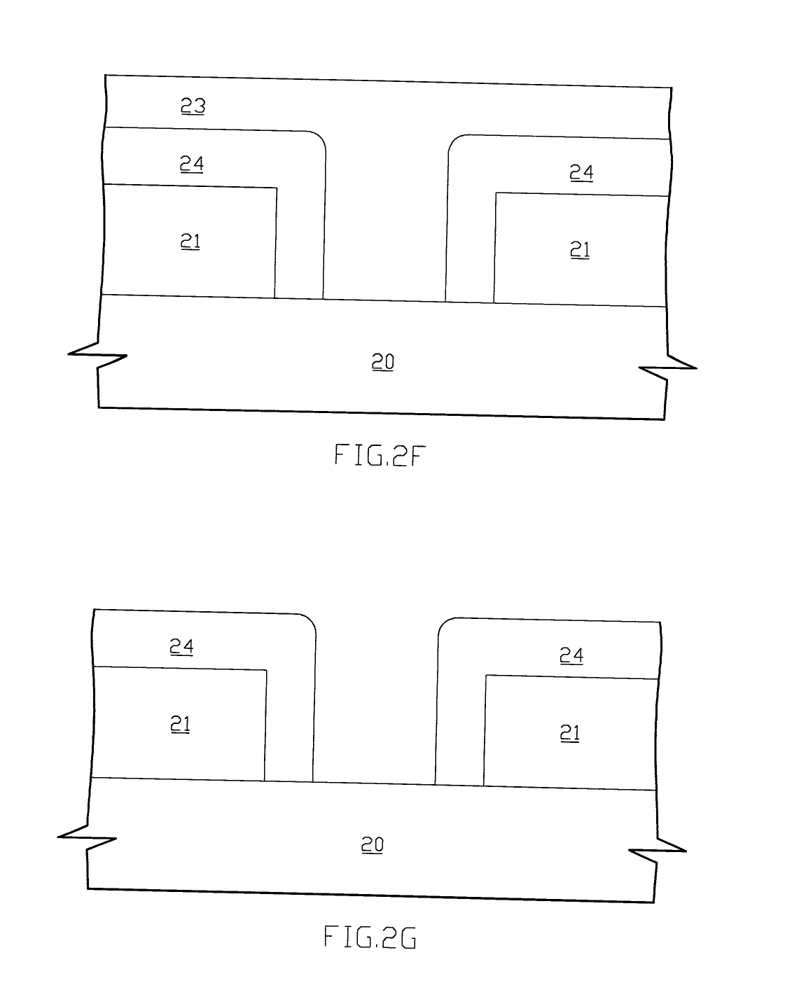

As FIG. 2A shows, provide substrate 20, such as semiconductor substrate or silicon substrate, moreover, substrate is capable of including at least one formed semiconductor structure, such as transistor or doped region.

As FIG. 2B shows, form photoresist 21 over substrate 20.

As FIG. 2C shows, pattern photoresist 21 to form patterned photoresist 21 over substrate 20. Herein, numerous ions 22 are formed during the formation of patterned photoresist 21 and are distributed over the surface of patterned photoresist 21. Moreover, the density of ions 22 is higher at the sidewall of patterned photoresist 21 and is lower at the top of patterned photoresist 21.

Further, numerous ions 22 usually are formed during the expose process, which is performed during patterning photoresist 21. In other words, ions 22 usually are formed by the interaction between the material of photoresist 21 and the light used by the expose process.

Moreover, ions 22 usually are the acid ions, such as the hydrogen ions. Besides, because material of photoresist 21 must be capable of generating ions 22, photoresist 21 could be formed of a mixture comprising a novolac-based resin and a naphtho-quinone diazide photosensitive agent, be formed of a mixture comprising a poly-hydroxy-styrene derivative and an onium salt serving as an photo-assisted acid generator, or be selected from the negative type resists which are made of a mixture of a crosslinkable compound, an acid generator and a base polymer.

Sequentially, treat patterned photoresist 21 to let the density of ions 22 at the top of patterned photoresist 21 be about equal to the density of ions 22 at the sidewall of patterned photoresist 21.

In this preferred embodiment, first available treatment is to re-distribute the non-uniform distributed ions 22 after patterned photoresist 21 is formed, as FIG. 2D shows. And second available treatment is to for new ions at the place where the density of ions 22 is less after patterned photoresist 21 is formed, as FIG. 2E shows.

First available treatment is to treat patterned photoresist 21 by a thermal treatment. Because heat is capable of inducing thermal diffusion of ions 22, partial ions 22 would diffuse from the sidewall of patterned photoresist 21, where the ions density is higher, to the top of patterned photoresist 21, where the ions density is lower. Obviously, the thermal diffusion of ions 22 would be continuously until the ions density is uniform over the whole surface of patterned photoresist 21 or the thermal treatment is terminated. Thus, after full thermal treatment, non-uniform distribution of ions 22 could be eliminated. In other words, the source of corner round profile is effectively eliminated.

Furthermore, in order to enhance the efficiency of the thermal treatment, such as to let the heat is direct applied at patterned photoresist 21 and/or to reduce the thermal damage on substrate 20, especially on formed semiconductor structure(s) inside substrate 20. It is better to let the thermal treatment directly apply a heat at the surface of patterned photoresist 21 but not heat patterned photoresist 21 by firstly heating substrate 20. For example, the thermal treatment could use a thermal source which is located over patterned photoresist 21.

In contrast, second available treatment is to treat patterned photoresist 21 by an illumination. Because ions 22 are formed by the reaction between the material of photoresist 21 and the light used to expose photoresist 21, the illumination could let similar reaction be happened and form more ions 22.

For example, the illumination could use a mercury lamp to provide the required light, and the light used to illuminate patterned photoresist 21 usually is chosen from the group consisting of g-ray and u-ray.

However, it should be note the illumination should be adjusted to let patterned photoresist 21 be not removed by the illumination. At least, it should be adjusted to let the effect of the removed quantity of patterned photoresist 21 be negligible while required number of ions 22 being formed.

Additional, because the illumination could form ions 22, and because the ions density is smaller at the top of patterned photoresist 21 after patterned photoresist 21 is formed, it is better to let the illumination only illuminate the top of patterned photoresist 21, to force newly formed ions 22 are concentrated at the top of patterned photoresist 21 and to ensure the non-uniform distribution of ions 22 could be eliminated by properly illumination.

As FIG. 2F shows, cover patterned photoresist 21 by reactive layer 23. Herein, the reaction between reactive layer 23 and ions 22 forms crosslinked layer 24 over the surface of patterned photoresist 21. Note that ions 22 are uniformly distributed over the whole surface of patterned photoresist 21 now, indisputably, thickness of formed crosslinked layer 24 would be uniform and then no corner round profile would be appeared.

Moreover, because the material of reactive layer 23 must be capable of undergoing a crosslinking reaction in the presence of ions 22, reactive layer 23 could be formed of a material which comprises a crosslinking agent, undergoing crosslinking reaction in the presence of said acid, reactive layer 23 also could be formed of a material which is selected from a group of polyvinyl acetal, a mixture of polyvinyl acetal and methoxy-methylolurea, a mixture of polyvinyl acetal and methoxy-methylol-melamine, or a mixture of methoxy-methylol-melamine and polyallyl-amine.

As FIG. 2G shows, remove non-crosslinked portions of reactive layer 23. Because no corner round profile would be appeared, indisputably, the efficiency and accuracy of the RELACS are improved by this present invention.

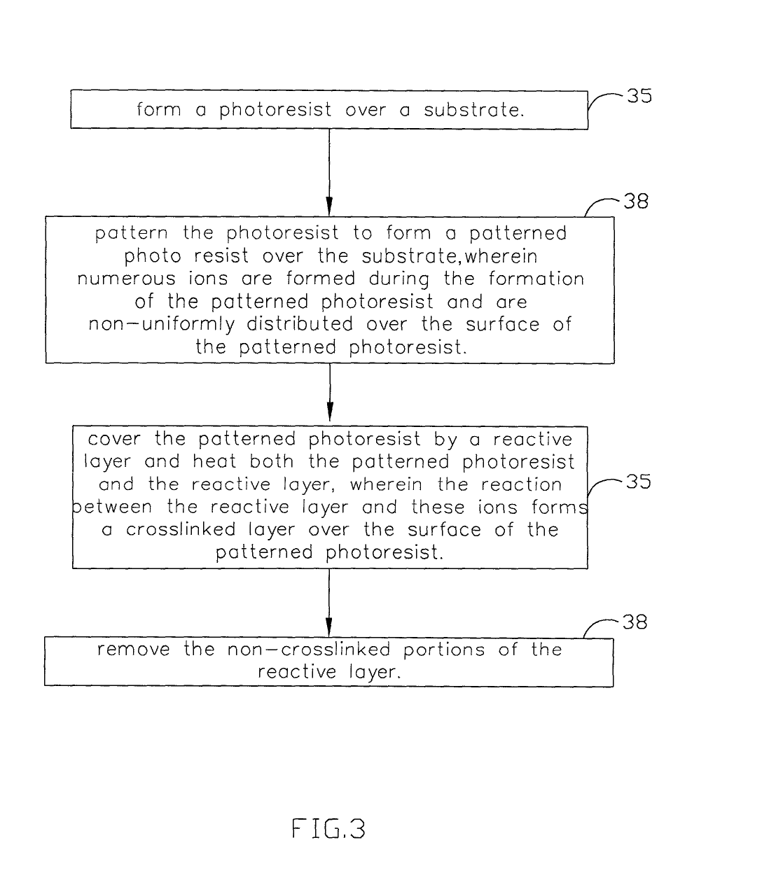

Another preferred embodiment of this present invention also is a method for eliminating corner round profile of the RELACS process. As FIG. 3 shows, the embodiment at least has following steps:

As background block 31 shows, form a photoresist over a substrate.

As pattern block 32 shows, pattern the photoresist to form a patterned photoresist over the substrate, wherein numerous ions are formed during the formation of the patterned photoresist and are distributed over the surface of the patterned photoresist. Moreover, the ions density is higher at the sidewall of the patterned photoresist and is lower at the top of the patterned photoresist.

As thermal treatment block 33 shows, cover the patterned photoresist by a reactive layer and heat both the patterned photoresist and the reactive layer, wherein the reaction between the reactive layer and these ions forms a crosslinked layer over the surface of the patterned photoresist.

Again, the thermal treatment of both the patterned photoresist and the reactive layer could let these ions be re-distributed and the let distribution of these ions is uniform. Moreover, as usual, both the patterned photoresist and the reactive layer are heated from the top of the reactive layer, which means heat from the top of patterned photoresist.

However, it should be noted that these ions not only are re-distributed over the surface of patterned photoresist, but also are diffused into neighboring part of the reactive layer. Thus, to perform the thermal treatment after the reactive layer is formed, both the thickness of crosslinked layer is uniform over the whole surface of patterned photoresist, and the thickness of crosslinked layer is increased.

As clean block 34 shows, remove the non-crosslinked portions of the reactive layer.

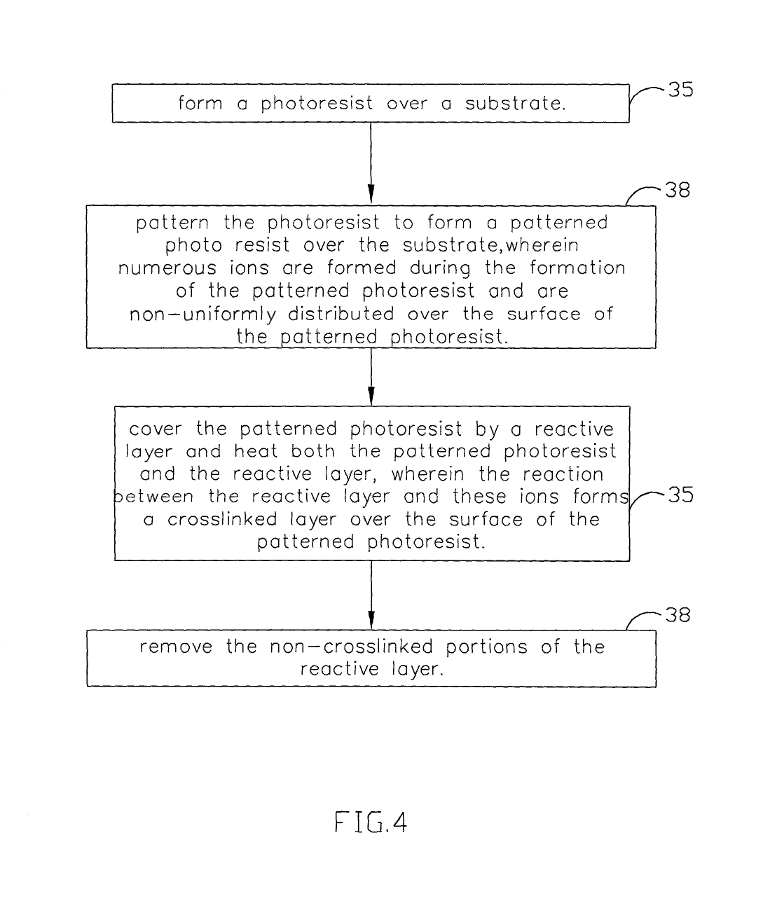

Still another preferred embodiment of this present invnetion also is a method for eliminating corner round profile of the RELACS process. As FIG. 4 shows, the embodiment at least has following steps:

As background block 41 shows, form a photoresist over a substrate.

As pattern block 42 show, pattern the photoresist to form a patterned photoresist over the substrate, wherein numerous ions are formed during the formation of the patterned photoresist and are distributed over the surface of the patterned photoresist. Moreover, the ions density is higher at the sidewall of the patterned photoresist and is lower at the top of the patterned photoresist.

As illumination block 43 shows, cover the patterned photoresist by a reactive layer and illuminate both the patterned photoresist and the reactive layer, wherein the reaction between the reactive layer and the ions forms a crosslinked layer over the surface of the patterned photoresist.

Again, the illumination of both the patterned photoresist and the reactive layer could let some ions be formed at the surface of the patterned photoresist and the let distribution of these ions is uniform.

Moreover, as usual, both the patterned photoresist and the reactive layer are illuminated from the top of the reactive layer, which means heat from the top of patterned photoresist, to ensure most of newly formed ions are formed at the top of the patterned photoresist to eliminate the difference between the ions density at the sidewall of the patterned photoresist and ions density at the top of the patterned photoresist. For example, both the patterned photoresist and the reactive layer could be illuminated by the usage of a mask which only expose the top of the patterned photoresist.

However, it should be noted that these ions essentially only are re-formed over the surface of patterned photoresist, especially re-formed at the top of the patterned photoresist, but essentially are not diffused into neighboring part of the reactive layer. Thus, to perform the illumination after the reactive layer is formed, only the thickness of crosslinked layer is uniform over the whole surface of patterned photoresist, but the thickness of crosslinked layer is not increased.

As clean block 44 shows, remove the non-crosslinked portions of the reactive layer.

In short, according to the above discussions, it is clear that the treatment, both thermal treatment and illumination, could be performed before the reactive layer is formed or after the reactive layer is formed. This present invention is not limited by when to perform the treatment. However, to perform this treatment before the reactive layer is formed, the acceptable parameters' ranges of the treatment, such as temperature and period, are larger for there is no requirement to consider the effect that the treatment affect the reactive layer, and the efficiency of this treatment also is higher for the treatment could directly affect the patterned photoresist. In contrast, to perform this treatment after the crosslinked layer is formed, the acceptable parameters' ranges of the treatment, such as temperature and period, are smaller for there is requirement to consider the effect that the treatment affect the crosslinked layer, but the effect of this treatment is higher for the treatment could increase the thickness of the crosslinked layer now.

Obviously, numerous additional modifications and variations of the present invention are possible in light of the above teachings. It is therefore to be understood that within the scope of the appended claims, the invention may be practiced otherwise than as specifically described herein.

What is claimed is

1. A method for eliminating corner round profile of the RELACS process, comprising:
providing a substrate;
forming a photoresist over said substrate;
patterning said photoresist to form a patterned photoresist over said substrate, wherein a plurality of ions are formed during the formation of said patterned photoresist and are distributed over the surface of said patterned photoresist
treating said patterned photoresist to let the density of said ions at the top of said patterned photoresist be similar with the density of said ions at the sidewall of said patterned photoresist.

2. The method of claim 1, wherein the expose process performed during patterning said photoresist forms said ions at the surface of said patterned photoresist

3. The method of claim 1, said ions being a plurality of acid ions.

4. The method of claim 1, said ions comprising a plurality of hydrogen ions.

5. The method of claim 1, said photoresist being formed of a mixture comprising a novolac-based resin and a naphtho-quinone diazide photosensitive agent.

6. The method of claim 1, said photoresist being formed of a mixture comprising a poly-hydroxy-styrene derivative and an onium salt serving as an photo-assisted acid generator.

7. The method of claim 1, said photoresist being selected from the negative type resists which are made of a mixture of a crosslinkable compound, an acid generator and a base polymer.

8. The method of claim 1, said patterned photoresist being treated by a thermal treatment.

9. The method of claim 8, said thermal treatment using a thermal source which is located over said patterned photoresist.

10. The method of claim 8, said thermal treatment directly applying a heat at the surface of said patterned photoresist, but not heating said patterned photoresist by firstly heating said substrate.

11. The method of claim 1, said patterned photoresist being treated by an illumination.

12. The method of claim 11, said illumination using a mercury lap to provide the required light.

13. The method of claim 11, the light used to illuminate said patterned photoresist being chosen from the group consisting of g-ray and u-ray.

14. The method of claim 11, said illumination only illuminating the top of said patterned photoresist.

15. The method of claim 1, said RELACS process using a reactive layer to let a crosslinked layer be formed by the reaction between siad patterned photoresist and said reactive layer, the material of said reactive layer comprising a crosslinking agent, undergoing crosslinking reaction in the presence of said acid.

16. The method of claim 16, said reactive layer being formed of a material which is selected from a group of polyvinyl acetal, a mixture of polyvinyl acetal and methoxy-methylolurea, a mixture of polyvinyl acetal and methoxy-methylol-melamine, or a mixture of methoxy-methylol-melamine and polyallyl-amine.

17. A method for eliminating corner round profile of the RELACS process, comprising:
forming a photoresist over a substrate;
patterning said photoresist to form a patterned photoresist over said substrate, wherein a plurality of ions are formed during the formation of said patterned photoresist and are distributed over the surface of said patterned photoresist
covering said patterned photoresist by a reactive layer and heating both said patterned photoresist and said reactive layer, wherein the reaction between said reactive layer and said ions forms a crosslinked layer over the surface of said patterned photoresist; and
removing non-crosslinked portions of said reactive layer.

18. The method of claim 17, said patterned photoresist and said reactive layer being heated from the top of said reactive layer.

19. A method for eliminating corner round profile of the RELACS process, comprising:
forming a photoresist over a substrate;
patterning said photoresist to form a patterned photoresist over said substrate, wherein a plurality of ions are formed during the formation of said patterned photoresist and are distributed over the surface of said patterned photoresist
covering said patterned photoresist by a reactive layer and illuminating both said patterned photoresist and said reactive layer, wherein the reaction between said reactive layer and said ions forms a crosslinked layer over the surface of said patterned photoresist; and
removing non-crosslinked portions of said reactive layer.

20. The method of claim 19, said patterned photoresist and said reactive layer being illuminated by the usage of a mask which only expose the top of said patterned photoresist.
